(19) United States
(12) Patent Application Publication
(10) Pub. No.: US 2006/0034273 A1
(43) Pub. Date: Feb. 16, 2006

(54) Transport stream processing apparatus

(75) Inventor: Sou Tamura, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/182,749

(22) Filed: Jul. 18, 2005

(30) Foreign Application Priority Data
Jul. 22, 2004 (JP) P2004-214413

(51) Int. Cl. H04L 12/56

(52) U.S. Cl. 370/389

(57) ABSTRACT

According to the present invention, a processing switching device switches to and from a hardware transport stream separating device and a software transport stream separating device in executing a partial processing included in a plurality of processings for separating desired data from a transport stream (TS). When the processing switching device instructs the execution of the partial processing in the software transport stream separating device, an output unit outputs data currently being processed and to be processed in the partial processing from the hardware transport stream separating device and stores the outputted data in a memorizing device. The software transport stream separating device reads the currently-processed data stored in the memorizing device and executes the partial processing thereto, and then stores the processed data in the memorizing device. The processed data stored in the memorizing device is read by an input unit and inputted to a residual processing of the hardware transport stream separating device executed after the partial processing.

### BACKGROUND OF THE INVENTION

1. Field of the Invention

The present invention relates to a transport stream processing method for processing data inputted by means of a transport stream packet format (hereinafter, referred to as TSP) and an apparatus for implementing the method in a digital broadcast receiver, and the digital broadcast receiver comprising the apparatus.

2. Description of the Related Art

The CS digital broadcast has been made available since 1995, and the BS digital broadcast has been made available since Dec. 1, 2000 in Japan. A broadcast station transmitting the foregoing broadcasts multiplexes image information and audio information obtained by compressing digital information and additional information appended to the informations such as program information according to the MPEG2 system standard to thereby generate a transport stream (TS), and digitally modulates and transmits the generated transport stream (TS). A digital broadcast receiver digitally demodulates the received signal to thereby obtain the transport stream (TS), and then separates the image, audio and other inforamtions from the obtained transport stream (TS) and reproduce them.

In the CS and BS digital broadcasts, the multiplexed data such as the image and audio is superposed on the transport stream (TS) as described, which is a data string having a fixed length generally called a transport stream packet (TSP), and then transmitted.

FIG. 3 is a schematic view illustrating a general format of the transport stream packet (TSP). The transport stream packet (TSP) is a packet having the fixed length of 188 bytes, the first four bytes of which are called a packet header. In the packet header, the first byte is a synchronous byte for synchronizing with a processing apparatus for processing the transport stream packet (TSP), in which a data value is always “47h” (h denotes a hexadecimal number). Subsequent to the first byte, a transport error indicator (TEI) bit for indicating “1” when a data error is detected in a digital demodulating circuit, a payload unit start indicator (PUSI) bit for denoting the presence of a section or a leading position of a packaged elementary stream (PES) packet, a transport scramble control (TSC) bit for indicating scramble information of the TSP, an adaptation field control (AFC) bit for indicating the presence/absence of an adaptation field, a continuity counter (CC) for indicating a packet continuity, and the like, are assigned in the packet header.

The fifth byte and thereafter of the transport stream packet (TSP) are comprised of an adaptation field of a variable length (N bytes) and a payload of a variable length (188-4-N bytes). The payload area stores the PES packet including the image, audio and subtitle, information for identifying a recipient, various service informations and the like. The transport stream packet (TSP) is scrambled so that data can be viewed/listened by particular subscribers and then transmitted. Further, in the digital broadcast receiver, the received transport stream packet (TSP) is filtered so that only necessary data is retrieved therefrom. Accordingly, the digital broadcast receiver descrambles and filters the transport stream packet (TSP) and outputs the descrambled and filtered TSP. As examples of a destination of the output, a memory accessible by a CPU, an AV decoder for retrieving the audio/image, and the like, can be mentioned.

An apparatus, which applies the filtering processing, descrambling processing and the like to the transport stream packet (TSP) to thereby retrieve the desired data as in the described manner, is called a transport stream processing apparatus. The filtering processing includes a PID filtering processing and a section filtering processing. The PID filtering processing outputs only the necessary transport stream packet (TSP) based on program identification data (hereinafter, referred to as identification data (PID)) of the transport stream packet (TSP) and discards the unnecessary transport stream packet (TSP). The section filtering processing retrieves a section from the transport stream packet (TSP) and filters a header part of the section to thereby output only the necessary section and discard the unnecessary section.

A conventional transport stream processing apparatus ranges in the following three constitutions. In one of them, all of the processing steps for the transport stream separation, such as the PID filtering and descrambling, are executed by hardware. In the other two constitutions, all of the processing steps for the transport stream separation are executed by software, and the processing steps for the transport stream separation are divided between the hardware and the software in such manner that the PID filtering and descrambling are hardware-executed and the section filtering and CRC check are software-executed.

Examples of the transport stream separating apparatus for executing all of a plurality of processing steps for the transport stream separation by the hardware are disclosed in No. H10-341419, No. 2000-13448 (P2000-13448A) and No. H11-239186 of the Publication of the Unexamined Japanese Patent Applications. An example of the transport stream separating apparatus for dividing the plurality of processing steps for the transport stream separation between the hardware and software is disclosed in No. H10-210461 of the Publication of the Unexamined Japanese Patent Applications.

The foregoing conventional constitutions of the transport stream separation have the following problems. When the plurality of processing steps for the transport stream separation is entirely executed on the hardware, additional circuits are demanded in order to deal with all of possible circumstances and statuses (for example, multiple-type scrambling method and the like). On the other hand, when the plurality of processing steps is entirely executed on the software, a high power for the CPU is constantly required. In the case of the constitution in which the processing steps are divided, a maximum performance may not be exerted if the processing steps are divided in a fixed manner

### SUMMARY OF THE INVENTION

Therefore, a main object of the present invention is to provide a transport stream processing apparatus capable of flexibly expanding its specification and a digital broadcast receiver comprising the transport stream processing apparatus.

In order to attain the foregoing object, a transport stream processing apparatus for executing a plurality of processing steps in order to separate desired data from a transport stream (TS) is constituted as follows.

A transport stream processing apparatus according to the present invention comprises a processor, a memorizing device accessible by software operated on the processor, a hardware transport stream separating device for executing the plurality of processing steps, a software transport stream separating device for executing a part of the plurality of processing steps (hereinafter, referred to as a partial processing), the software transport stream separating device being operated on the processor, and a processing switching device for switching to and from the hardware transport stream separating device and the software transport stream separating device in executing the partial processing.

The hardware transport stream separating device comprises an output unit and an input unit. The output unit outputs data currently being processed and to be processed in the partial processing from the hardware transport stream separating device and stores the outputted data in the memorizing device.

The software transport stream separating device reads the currently-processed data stored in the memorizing device and executes the partial processing thereto to thereby store the processed data in the memorizing device when the processing switching device instructs the execution of the partial processing in the software transport stream separating device.

The input unit reads the processed data memorized in the memorizing device and inputs the read data to a residual processing executed after the partial processing in the hardware transport stream separating device when the processing switching device instructs the execution of the partial processing in the software transport stream separating device.

The transport stream processing apparatus according to the present invention is capable of switching to and from the hardware and the software in executing the partial processing using the processing switching device. To put it differently, the transport stream processing apparatus according to the present invention is capable of selectively executing the hardware processing or the software processing in executing the transport stream separation.

Therefore, according to the present invention, processing performances of the hardware and the software can be efficiently utilized, and the transport stream processing apparatus capable of flexibly expanding its specification and the digital broadcast receiver comprising the transport stream processing apparatus can be realized.

### BRIEF DESCRIPTION OF THE DRAWINGS

Other objects of the invention will become clear by the following description of preferred embodiments and explicit in the appended claims of the invention. Many other benefits of the invention, which are not recited in this specification, will come to the attention of those skilled in the art upon implementing the present invention.

FIG. 1 is a block diagram illustrating an entire constitution of a transport stream processing apparatus according to a preferred embodiment of the present invention.

FIG. 2A is a flow chart according to the preferred embodiment.

FIG. 2B is a first modified example of the flow chart according to the preferred embodiment.

FIG. 2C is a second modified example of the flow chart according to the preferred embodiment.

FIG. 3 shows a constitution of a transport stream packet.

FIG. 4 is a block diagram illustrating a basic constitution of a transport stream processing apparatus to which the present invention is implemented.

FIG. 5 is a flow chart in the basic constitution of the transport stream processing apparatus to which the present invention is implemented.

### DETAILED DESCRIPTION OF A PREFERRED EMBODIMENT

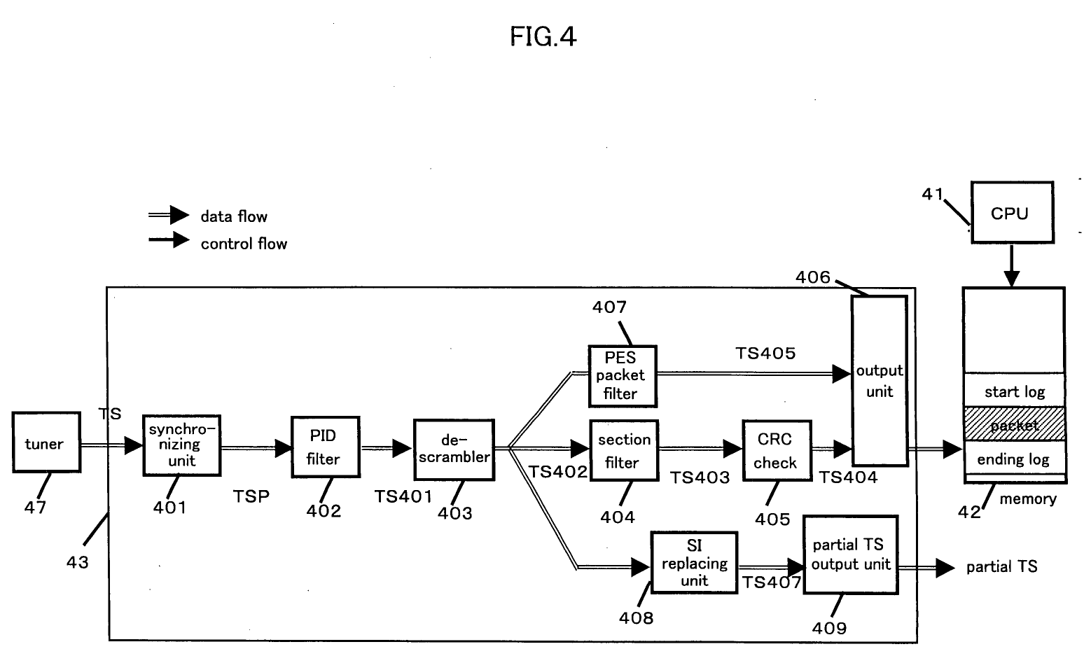

Prior to the description of a preferred embodiment of the present invention, an outline of a basic constitution relating to data reception in a digital broadcast receiver to which the present invention is implemented is described referring to FIG. 4.

In the digital broadcast receiver, a CPU (processor) 41, a memory (memorizing device) 42, a tuner 47 and a transport stream processing apparatus 43 are mainly responsible for the data reception.

The CPU 41 functions as a processor. The memory 42 is adapted to be accessible by software operated on the CPU 41. The tuner 47 frequency-selects a targeted carrier wave from received electric waves, demodulates and error-corrects the carrier wave, and further selects a transport stream from the carrier wave to thereby output the transport stream. In FIG. 4, a data flow and a control flow are respectively shown in arrows.

The transport stream processing apparatus 43 comprises a synchronizing unit 401, a PID filter 402, a descrambler 403, a section filter 404, a CRC checking unit 405, an output unit 406, a PES packet filter 407, a service information (SI) replacing unit 408 and a partial TS output unit 409. Identification data (PID) refers to a packet identification data and synonymous with a packet identifier.

The synchronizing unit 401 detects leading data from the inputted transport stream (TS), and then extracts and outputs a transport stream packet (TSP).

The PID filter 402 outputs only the necessary transport stream packet (TSP) as TS401 and discards the unnecessary transport stream packet (TSP) based on identification data (PID) of the transport stream packet (TSP) inputted from the synchronizing unit 401.

The descrambler 403 judges a transport scramble control (TSC) of the transport stream packet (TSP) as the TS401 inputted from the PID filter 402, and descrambles the TS401 and outputs it as TS402 when the TS401 is judged to be scrambled. The descrambler 403 dispenses with any processing with respect to the TS401 and immediately outputs it as the TS402 when the TS401 is judged to be non-scrambled. The descrambler 403 executes the foregoing descrambling processing on hardware.

The section filter 404 retrieves a section from the inputted TS402 (post-descrambling transport stream packet (TSP)) and filters a header part of the retrieved section to thereby output only the necessary section as TS403 to the CRC checking unit 405 and discard the unnecessary section.

The CRC checking unit 405 checks a CRC error (cyclic redundancy check error) of the section in the inputted TS403 to thereby append a result of the CRC check to the section and output it as TS404 to the output unit 406.

The output unit 406 outputs the inputted TS404 to the memory 42. However, the section including no CRC (section whose section syntax indicator (SSI)=0) is not subjected to the CRC check in the CRC checking unit 405 and outputted from the output unit 406.

The PES packet filter 407 retrieves a PES packet from the inputted TS402 and executes a filtering processing in order to judge whether or not the retrieved PES packet is a necessary PES packet. Then, the PES packet filter 407 outputs the PES packet judged to be necessary as TS405 to the output unit 406, while discarding the PES packet judged to be unnecessary. The output unit 406 outputs the inputted TS405 to the memory 42.

The service information (SI) replacing unit 408 and the partial TS output unit 409 are adapted to retrieve a necessary program from the inputted transport stream (TS) and output the retrieved program as a partial transport stream (PTS).

The service information (SI) replacing unit 408 synthesizes the inputted TS402 and the transport stream packet (TSP) including the section in which program information of the partial transport stream (PTS) is stored to thereby output a result of the synthesis as TS407 to the partial TS output unit 409.

Data stored in the section as the program information includes PAT (program association table), PMT (program map table), SIT (selection information table), DIT (discontinuity information table) and the like.

The partial TS output unit 409 outputs the inputted TS407 as the partial transport stream. (PTS) outside of the transport stream processing apparatus.

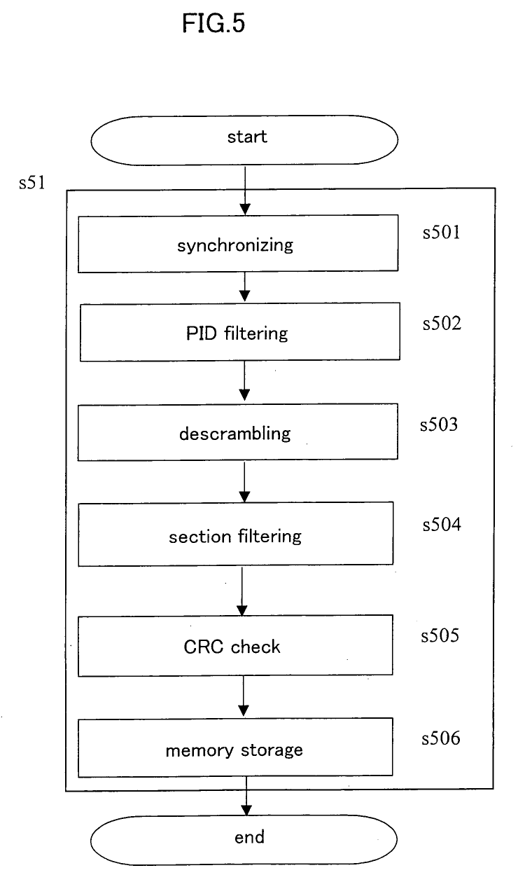

Next is described an example of the processing of the digital broadcast receiver in the case of obtaining the section referring to a flow chart of FIG. 5. The flow chart represents a transport stream separating step s51 using the hardware.

The step s51 comprises a synchronizing step s501, a PID filtering step s502, a descrambling step s503, a section filtering step s504, a CRC checking steps 505 and a memory storing step s506.

The synchronizing step s501 detects the leading data from the inputted transport stream (TS) and then extracts the transport stream packet (TSP). The extracted transport stream packet (TSP) is provided with time stamp information indicating an arrival time thereof.

The PID filtering step s502 retrieves and outputs only the necessary transport stream packet (TSP) and discards the unnecessary transport stream packet (TSP) based on the identification data (PID) of the transport stream packet (TSP) processed in the step s501.

The descrambling step s503 judges whether or not the relevant packet is scrambled based on the transport scramble control (TSC) stored in the transport stream packet (TSP) processed in the step s502. The descrambling step s503 descrambles the data when the data is judged to be scrambled, while omitting the descrambling processing when the data is judged to be non-scrambled.

The section filtering step s504 retrieves the section from the transport stream packet (TSP) processed in the step s504 and filters the header part of the section to thereby retrieve the necessary section and discard the unnecessary section.

The CRC checking step s505 checks the CRC error of the section processed in the step s504.

The memory storing step s506 outputs the data processed in the steps up to the s505 to the memory 42 accessible by the CPU 41.

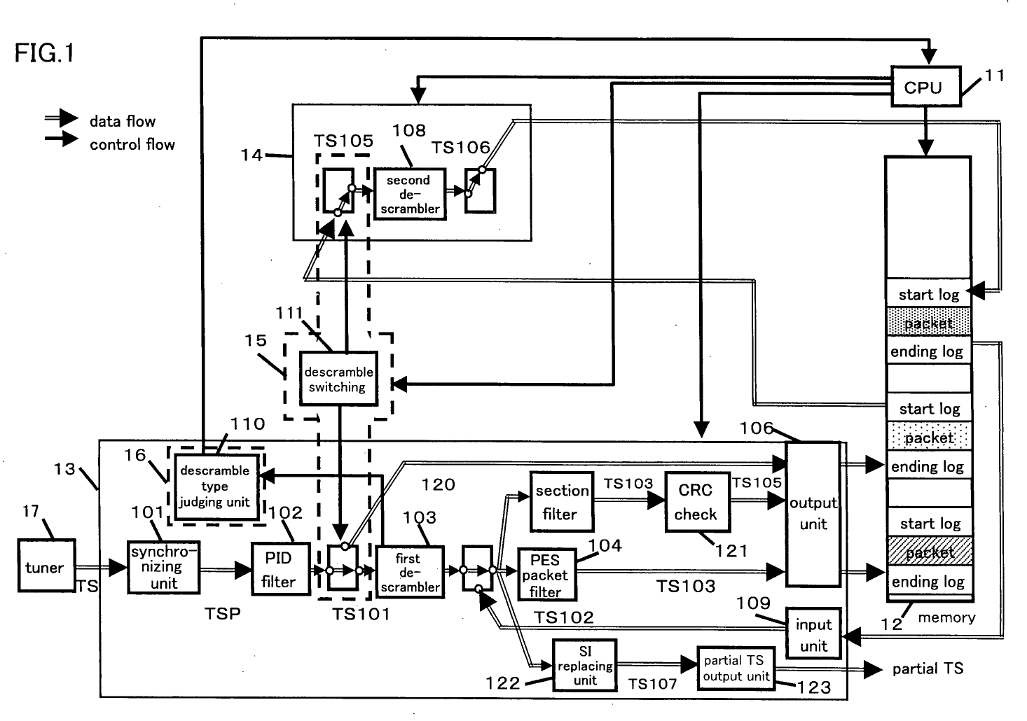

Next, the transport stream processing apparatus and the digital broadcast receiver comprising the transport stream processing apparatus according to the present embodiment are described in detail. FIG. 1 is a block diagram illustrating a schematic constitution relating to data reception in the digital broadcast receiver according to the present embodiment.

In the digital broadcast receiver, a CPU (processor) 11, a memory (memorizing device) 12, a tuner 17 and a transport stream processing apparatus are mainly engaged in the data reception in the same manner as in the constitution of FIG. 4. The memory 12 is adapted to be accessible by software operated on the CPU 11. The tuner 17 frequency-selects a targeted carrier wave from received electric waves, demodulates and error-corrects the carrier wave, and further selects a transport stream from the carrier wave and outputs the selected transport stream. In FIG. 1, a control flow and a data flow are respectively shown in single-lined arrows and double-lined arrows.

The transport stream processing apparatus is an apparatus for executing a plurality of processing steps in order to separate the desired data from the transport stream (TS).

The transport stream processing apparatus comprises a hardware transport stream separating device 13, a software transport stream separating device 14 and a processing switching device 15 for switching to and from the hardware transport stream separating device 13 and the software transport stream separating device 14 in executing the transport stream separation.

The hardware transport stream separating device 13 comprises a synchronizing unit 101, a PID filter 102, a first descrambler 103, a PE packet filter 104, an output unit 106, an input unit 109, a state judging device 16, a section filter 120, a CRC checking unit 121, a service information (SI) replacing unit 122 and a partial TS output unit 123.

The synchronizing unit 101 detects the leading data of the inputted transport stream (TS), and further extracts the transport stream packet (TSP) from the inputted the transport stream (TS).

The PID filter 102 outputs only the necessary TSP as TS101 from the transport stream packet (TSP) inputted from the synchronizing unit 101 and discards the unnecessary TSP. The identification of the necessary/unnecessary TSP is carried out based on the identification data (PID) of the TSP.

The first descrambler 103 judges the transport scramble control (TSC) in the transport stream packet (TSP) supplied from the PID filter 102, and descrambles the transport stream packet (TSP) and outputs the descrambled TSP as TS102 when a result of the judgment shows that the transport stream packet (TSP) is scrambled, while outputting the transport stream packet (TSP) as the TS102 without executing any processing when the judgment result shows that the TSP is non-scrambled. The first descrambler 103 executes the foregoing descrambling processing on the hardware. The descrambling processing corresponds to a partial processing included in the transport stream processing.

The PES packet filter 104 retrieves the PES packet from the TS102 inputted from the first descrambler 103 and filters the header of the PES packet to thereby output the necessary PES packet as TS103 to the output unit 106 and discard the unnecessary PES packet.

The section filter 120 retrieves the section from the inputted TS102 and filters the header part of the retrieved section to thereby output the necessary section as TS104 and discard the unnecessary section.

The CRC checking unit 121 checks the CRC (cyclic redundancy Check) of the section supplied from the section filter 104, and then appends the CRC check result to the section and output it as TS105 to the output unit 106.

The service information (SI) replacing unit 122 synthesizes the inputted TS102 and the transport stream packet (TSP) including the section required for outputting the partial transport stream (partial TS), and outputs the synthesizing result as TS107 to the partial TS output unit 123.

The partial TS output unit 123 outputs the inputted TS107 as the partial TS outside of the apparatus.

The output unit 106 outputs the output result of the PES packet filer 104 (TS103) to the memory 12, and further outputs the output result of the PID filter 102 (TS101) as an output example of an optional processing step to the memory 12. The outputted TS103 and TS101 are stored in the memory 12.

The input unit 109 reads the output of the PID filter 102 (TS101) memorized in the memory 12 and inputs the read output to the PES packet filter 104, which is an example of the constitution for executing a residual processing.

The state judging device 16 comprises a descramble type judging unit 110. The descramble type judging unit 110 identifies a scramble method of the TS101 outputted from the PID filter 102, and generates a processing switching control signal based on a result of the judgment and outputs the generated processing switching control signal to the processing switching device 15.

The software transport stream separating device 14 comprises a second descrambler 108. The second descrambler 108 executes the descrambling processing using the software, however, the executed descrambling processing itself is similar to the processing executed by the first descrambler 103.

In the present embodiment, the CPU 11 realizes a function of the processing switching device 15. The processing switching device 15 sets a descramble switching flag 111 and supplies the flag 111 to the hardware transport stream separating device 13 and the software transport stream separating device 14. The descramble switching flag 111 instructs the switchover between the descrambling by the first descrambler 103 and the descrambling by the second descrambler 108.

The software transport stream separating device 14 is operated on the CPU 11 as the software. The memory 12 is accessible by the software (software transport stream separating device 14 or the like) operated on the CPU 11.

Next, a processing of the state judging device 16 (descramble type judging unit 110) is described. The descramble type judging unit 110 identifies the scramble method of the TS101 outputted from the PID filter 102. The descramble type judging unit 110 further judges whether or not the identified scramble method can be descrambled by the first descrambler 103 (hardware). When it is judged that it is not possible to descramble the identified scramble method using the first descrambler 103, the descramble type judging unit 110 outputs the processing switching control signal indicating such to the processing switching device 15. The processing switching device 15 receives the processing switching control signal and correspondingly resets the descramble switching flag 111 to be effective, which indicates that the descrambling is executed by the software transport stream separating device 14.

On the contrary, when the descramble type judging unit 110 judges that the scramble method can be descrambled by the first descrambler 103, the processing switching control signal indicating such is outputted to the processing switching device 15. The processing switching device 15 receives the processing switching control signal and correspondingly maintains the setting of the descramble switching flag 111 as ineffective, which indicates that the descrambling is executed by the hardware transport stream separating device 13.

In the present embodiment, the CPU 11 outputs the processing switching control signal to the processing switching device 15 based on the judgment result of the descramble type judging unit 110 because the function of the processing switching device 15 is realized by the CPU 11. However, in a system in which the processing switching device 15 executes its processing independently from the CPU 15, the processing switching device 15, which is directly notified of the judgment result by the descramble type judging unit 110, may possibly execute the processing.

Hereinafter, the descrambling processing which is switched in response to the state of the descramble switching flag 111 is described in detail. When the descramble switching flag 11 is ineffective, the hardware transport stream separating device 13 descrambles the TS101 using the hardware-constituted first descrambler 103, while the software transport stream separating device 14 does not execute the descrambling processing using the software-constituted second descrambler 108.

More specifically, the TS101 outputted by the PID filter 102 is inputted to the first descrambler 103 based on the ineffective descramble switching flag 111. The first descrambler 103 judges the transport scramble control (TSC) of the TS101 to thereby descramble the TS101 if scrambled, while omitting the descrambling with respect to the TS101 if not scrambled. The TS101, which is thus appropriately descrambled, is inputted as the TS102 from the first descrambler 103 to the PES packet filter 104.

The PES packet filter 104 retrieves the PES packet from the inputted transport stream packet (TSP) and fitlers the header part of the PES packet. As a result of the filtering process, the necessary PES packet is provided with a PES packet start log and then outputted as the TS103 to the output unit 106, while the unnecessary PES packet is discarded. The output unit 106 outputs the TS103 to the memory 12.

As described, when the descramble switching flag 111 is ineffective, the processing switching device 15 (CPU 11) issues the instruction of descrambling the TS101 using the hardware transport stream separating device 13 to the memory 2. The hardware transport stream separating device 13, in response to the detection of the ineffective descramble switching flag 111, executes the descrambling. Therefore, in a control operation of the CPU 11 when the descramble switching flag 111 is ineffective, the TS103 outputted from the output unit 106 is stored in the memory 12.

On the contrary, when the descramble switching flag 111 is effective, the processing switching device (CPU 11) executes the descrambling using the software-constituted second descrambler 108 in the software transport stream separating device 14, while omitting the execution of the descrambling by the hardware-constituted first descrambler 103 in the hardware transport stream separating device 13.

When the descrambling processing is executed in the software transport stream separating device 14, the processing switching device 15 (CPU 11) issues the instruction of reading the non-scrambled TS101 from the memory 12 and outputting the read TS101 to the software transport stream separating device 14.

As an alternative method for software-descrambling the TS101 temporarily stored in the memory 12, the processing switching device 15 (CPU 11) may read the logs appended to the top and bottom of the packet stored in the memory 12, and then execute the processing switchover in response to a state of the logs. However, in the present embodiment, the state of the descramble switching flag 111 of the processing switching device 15, in place of the log, is judged, and the processing switchover is executed based on a result of the judgment. Below is given a description.

The hardware transport stream separating device 13, based on the effective descramble switching flag 111, does not supply the first descrambler 103 with the TS101 outputted from the PID filter 102, however, outputs the scrambled TS101 without changing the scramble state from the output unit 106 to the memory 12 and stores the TS101 in the memory 12. The TS101 in the scrambled state stored in the memory 12 is descrambled as follows based on the control of the CPU 11.

When it is confirmed that the descramble switching flag 111 is effective, the processing switching device 15 (CPU 11) reads from the memory 12 the respective packets of the TS101 in the scrambled state stored in the memory 12 and outputs the packets as the TS105 to the second descrambler 108 of the software transport stream separating device 14.

The second descrambler 108 receives the input of the TS105 and correspondingly judges the transport scramble control (TSC) of the TS105 to thereby descramble the TS105 using the software if the TS105 is scrambled, while omitting the execution of the descrambling processing if non-scrambled. The TS105 thus appropriately descrambled is outputted as TS106 from the second descrambler 108 to the memory 12 and stored in the memory 12, and then, read the read TS106 from the memory 12 as the TS102 based on the instruction of the processing switching device 15 (CPU 11) and inputted to the PES packet filter 104 via the input unit 109. The PES packet filter 104 corresponds to an apparatus in charge of the residual processing executed after the descrambling processing as the partial processing.

The processings thereafter including the packet filtering processing, which are executed by the PES packet filter 104, are executed in a similar manner in the case of the ineffective descramble switching flag 111.

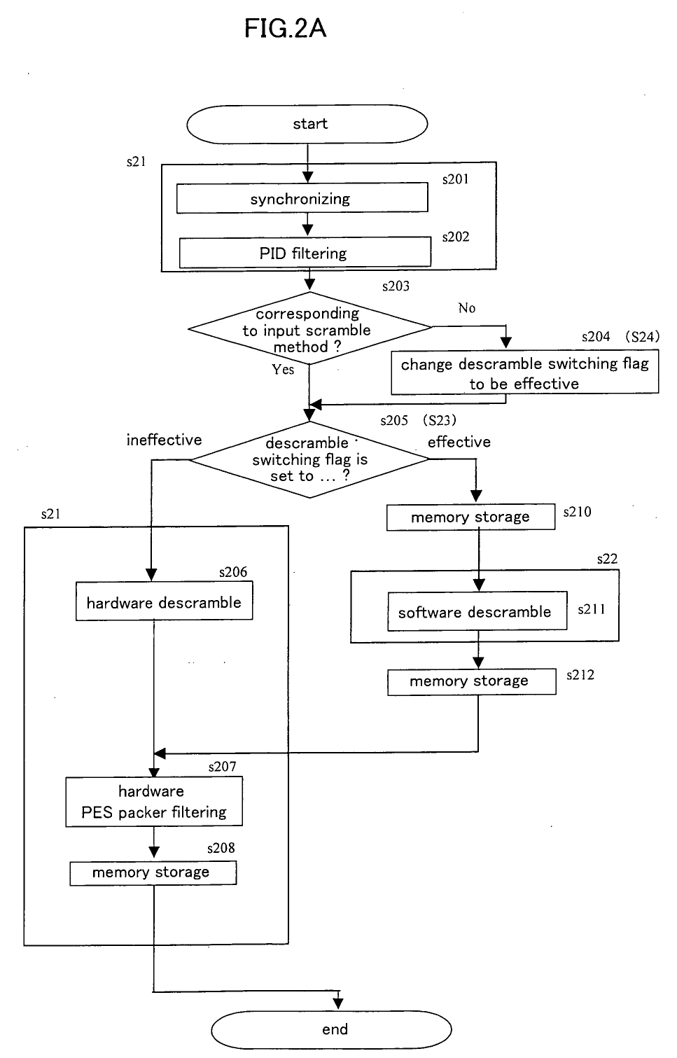

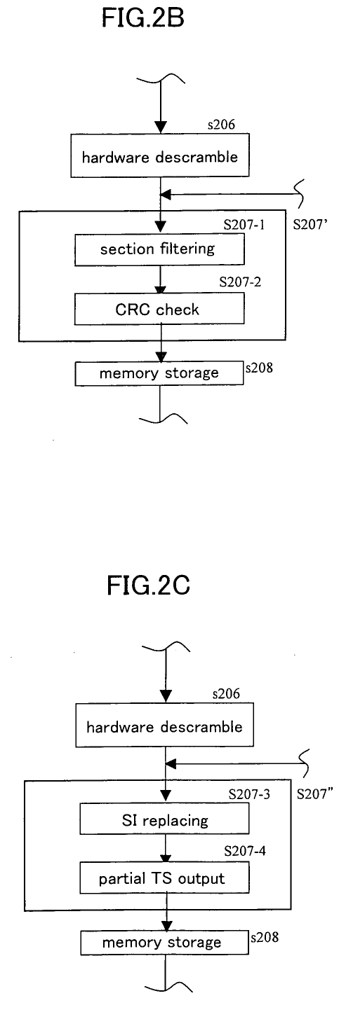

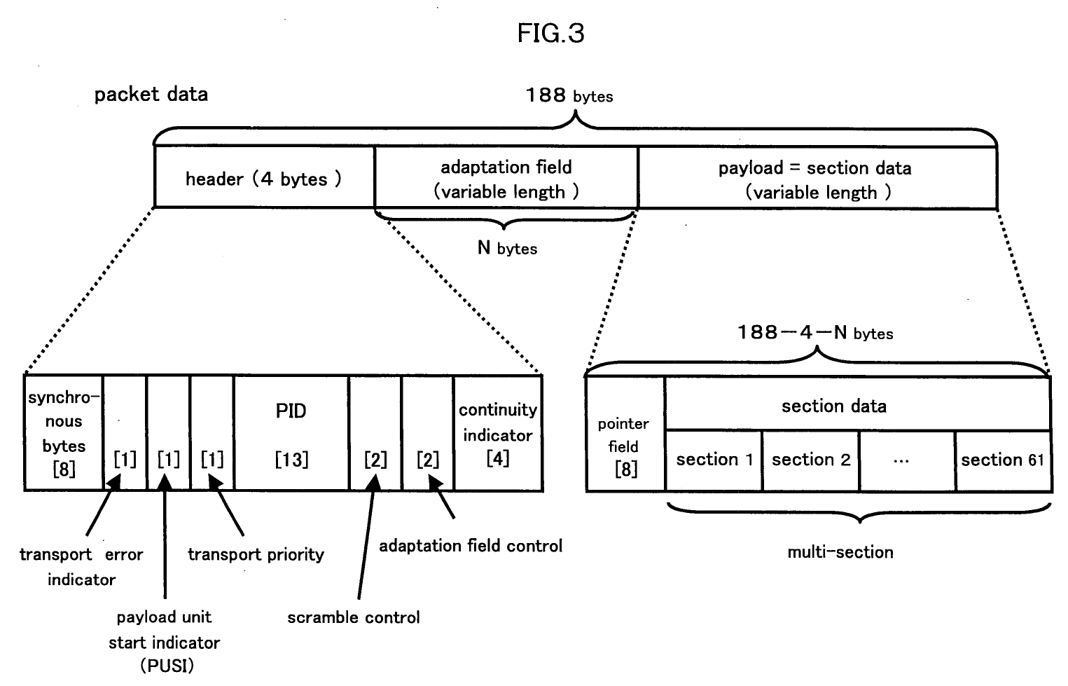

FIG. 2A is a flow chart of the descrambling processing according to the present embodiment.

In the present embodiment, a descrambler switching step s205 for switching to and from the hardware processing and the software processing of the descrambler is included as a processing switching step s23, and a scramble method judging step s203 is included as a state judging step s24.

As a hardware transport stream separating step s21, a synchronizing step s201, a PID filtering step s202, a hardware descrambling step s206, a hardware PES packet filtering step s207 and a memory storing step s208 are included.

As a software transport stream separating step s22, a descrambling step s211 is included.

Below is described a processing flow according to the present embodiment referring to the flow chart of FIG. 2A.

The step s201 is the synchronizing step, in which the leading data is detected from the inputted transport stream (TS) and the transport stream packet (TSP) is then extracted.

The step s202 is the PID filtering step, in which only the necessary transport stream packet (TSP) is retrieved and the unnecessary transport stream packet (TSP) is discarded based on the identification data (PID) of the inputted transport stream packet (TSP).

The steps s203 is the scramble method judging step, in which it is judged whether or not the scramble method of the transport stream packet (TSP) processed in the PID filtering step s202 can be descrambled in the hardware transport stream separating step s21 (in particular, descrambling step s206).

When it is judged in the step s203 that the descrambling processing using the hardware is not possible, the descramble switching flag 111 is changed to be effective in the step s204. Then, the processing proceeds to the step s205. In the step s205, it is judged whether or not the descramble switching flag 111 is ineffective.

When the descramble switching flag 111 is not judged to be ineffective (judged to be effective) in the step 205, the relevant transport stream packet (TSP) is identified as the data judged to be not possibly hardware-descrambled in the step s203, and the processing of the transport stream packet thereafter shifts to the group of steps of the software descrambling processing. To be more specific, the processing proceeds to a step s210.

The step s210 is the memory storing step, in which the transport stream packet (TSP) is not subjected to the hardware descrambling processing and stored in the memory 12.

The step s211 is the software descrambling processing step. In the step s211, the transport stream packet (TSP), which is not hardware-descrambled and stored in the memory 12, is read and software-descrambled. More specifically, first, the transport scramble control (TSC) of the transport stream packet (TSP) is judged. Then, when it is judged that the transport stream packet (TSP) is scrambled based on the judgment of the transport scramble control (TSC), the TSP is descrambled. On the other hand, when the TSP is judged to be non-scrambled, the descrambling processing is omitted.

A step s212 is the memory storing step, in which the transport stream packet (TSP) software-descrambled in the step s211 is stored in the memory 12, advances to the step s207.

The step s207 is the hardware PES packet filtering step, in which the transport stream packet (TSP) stored in the memory 12 in the step s212 is read and subjected to the hardware PES packet filtering process. To specifically describe the hardware PES packet filtering process, the PES packet is retrieved from the transport stream packet (TSP) and the header part of the PES packet is filtered. As a result of the filtering process, the necessary PES packet is provided with the PES packet start log, while the unnecessary PES packet discarded. The step s207 corresponds to the residual processing executed after the hardware descrambling processing s206 as the partial processing.

The step s208 is the memory storing step, in which the transport stream packet (TSP) subjected to the hardware PES packet filtering processing in the step s207 is stored in the memory 12.

On the contrary, when the descramble switching flag 111 is judged to be ineffective in the step s105, the transport stream packet (TSP) is identified as the data judged to be possibly hardware-descrambled in the step s203, and the processing of the relevant transport stream packet (TSP) thereafter shifts to the groups of steps of the hardware descrambling processing. To be specific, the processing proceeds to the step s206.

The step s206 is the hardware descrambling step, in which, first, the transport scramble control (TSC) of the transport stream packet (TSP) is judged, and the transport stream packet (TSP) is hardware-descrambled when the TSP is judged to be scrambled based on the judgment of the transport scramble control (TSC). When it is judged that the TSP is not scrambled, the hardware descrambling processing is omitted.

The step s207 is the PES packet filtering step, in which the PES packet is retrieved from the hardware-descrambled transport stream packet (TSP) and the header part of the PES packet is filtered so as to retrieve the necessary packet and discard the unnecessary packet. Then, the processing proceeds to the step s208.

The step s208 is the memory storing step, in which the transport stream packet (TSP) processed in the steps up to the s207 is stored in the memory 12 accessible by the CPU 11.

As shown in FIG. 2B, a step s207′ including a section filtering step s207-1 and a CRC checking step s207-2 may be executed in place of the PES packet filtering step s207.

In the section filtering step s207-1, the section is retrieved from the transport stream packet (TSP) and the header part of the retrieved section is filtered so as to retrieve only the necessary section. The step s207-1 is executed by the section filter 404.

In the CRC checking step s207-2, the CRC error (cyclic redundancy check error) of the section of the section-filtered transport stream (TS) is checked, and the CRC check result is appended to the checked section. The step s207-2 is executed by the CRC checking unit 405.

Further, as shown in FIG. 2C, a step s207″ including a SI replacing step s207-3 and a partial TS output step s207-4 may be executed in place of the PES packet filtering step s207.

In the SI replacing step s207-3, the transport stream (TS) and the transport stream packet (TSP) including the section in which program information of the partial transport stream (PTS) is stored are synthesized. The step s207-3 is executed by the SI replacing unit 122.

In the partial TS output step s207-4, the SI-replaced transport stream (TS) is outputted outside of the transport stream processing apparatus as the partial transport stream (PTS). The step s207-4 is executed by the partial TS output unit 409.

As is clear from the constitution shown in FIG. 1, the steps for executing the plurality of processings in the present embodiment includes:
synchronizing step for retrieving the data from the transport stream (TS) per the transport stream packet (TSP);
PID filtering step for filtering the transport stream packet (TSP) in accordance with the identification data (PID);
hardware descrambling step for descrambling the PID-filtered transport stream packet (TSP) using the hardware;
section filtering step for detecting the section as a transfer unit for transferring program information and user information in the PID-filtered and descrambled data and filtering the detected section in accordance with a section pattern;
CRC checking step for detecting the CRC error of the section;
descrambling step for descrambling the PID-filtered transport stream packet (TSP) using the hardware;
PES packet filtering step for detecting the PES packet as a transfer unit for transferring image, audio and subtitle in the PID-filtered and descrambled data and filtering the detected PES packet in accordance with a PES packet pattern;
service information (SI) replacing step for generating the transport stream packet (TSP) including the section required when the partial transport stream (partial TS) is outputted and synthesizing the generated TSP and the descrambled transport stream packet (TSP); and
partial TS output step for outputting the transport stream packet (TSP) synthesized in the service information (SI) replacing step as the partial TS.

Further, in the description of the present embodiment, the PES packet filtering processing is executed subsequent to the descrambling processing, however, a similar effect is attained when the other processings are executed. More specifically, in the present invention, the section filtering processing and the CRC check processing may be executed subsequent to the descrambling processing, or the service information (SI) replacing processing and the partial TS output processing may be executed thereafter as well.

As thus far described, the transport stream separating processing, which is not adapted to respond to the hardware, is executed on the software, a specification of the transport stream processing apparatus can be expanded without making any change to the hardware.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A transport stream processing apparatus for executing a plurality of processings for separating desired data from a transport stream (TS) comprising:
a processor;
a memorizing device accessible by software operated on the processor;
a hardware transport stream separating device for executing the plurality of processings;
a software transport stream separating device for executing a part of the plurality of processing steps (hereinafter, referred to as partial processing), the software transport stream separating device being operated on the processor; and
a processing switching device for switching to and from the hardware transport stream separating device and the software transport stream separating device in executing the partial processing, wherein
the hardware transport stream separating device comprises an output unit and an input unit,
the output unit outputs data currently being processed and to be processed in the partial processing from the hardware transport stream separating device and stores the outputted data in the memorizing device when the processing switching device instructs execution of the partial processing in the software transport stream separating device,
the software transport stream separating device reads the currently-processed data stored in the memorizing device and executes the partial processing thereto and stores the processed data in the memorizing device when the processing switching device instructs the execution of the partial processing in the software transport stream separating device, and
the input unit reads the processed data stored in the memorizing device and inputs the read processed data to a residual processing executed after the partial processing in the hardware transport stream separating device when the processing switching device instructs the execution of the partial processing in the software transport stream separating device.

2. A transport stream processing apparatus as claimed in claim 1, wherein
the hardware transport stream separating device comprises a state judging device,
the state judging device detects a state of the hardware transport stream separating device and outputs the detected state to the processing switching device, and
the processing switching device switches to and from the hardware transport stream separating device and the software transport stream separating device in executing the partial processing in response to the state of the hardware transport stream separating device inputted from the state judging device.

3. A transport stream processing apparatus as claimed in claim 2, wherein
the partial processing includes a descrambling processing of the transport stream (TS),
the state judging device detects an adaptation status of the descrambling processing the transport stream separating devices with respect to the transport stream (TS) and outputs the detected adaptation status to the processing switching device,
the processing switching device sets a descramble switching flag in accordance with the adaptation status inputted from the state judging device,
the hardware transport stream separating device descrambles the currently-processed data when the descramble switching flag is ineffective, and
the software transport stream separating device descrambles the currently-processed data when the descramble switching flag is effective.

4. A transport stream processing apparatus as claimed in claim 3, wherein
the hardware transport stream separating device outputs the currently-processed data via the output unit and stores the outputted data in the memorizing device when the descramble switching flag is effective,
the software transport stream separating device reads the currently-processed data from the memorizing device, software-descrambles the read data and stores the descrambled data in the memorizing device when the descramble switching flag is effective, and
the hardware transport stream separating device reads the descrambled data from the memorizing device via the input unit and inputs the read data to the residual processing executed by the hardware transport stream separating device after the partial processing when the descramble switching flag is effective.

5. A transport stream processing apparatus as claimed in claim 3, wherein
the state judging device judges a scramble state of the transport stream (TS) to thereby judge whether or not the transport stream (TS) can be descrambled by the hardware transport stream separating device, and
the processing switching device switches to and from the hardware transport stream separating device and the software transport stream separating device in executing the partial processing based on a result of the judgment of the state judging device.

6. A transport stream processing apparatus as claimed in claim 1, wherein
the hardware transport stream separating device comprises as components for executing the plurality of processings:
a synchronizing unit for retrieving the data from the inputted transport stream (TS) per a transport stream packet (TSP);
a PID filter for filtering the inputted transport stream packet (TSP) in accordance with identification data (PID);
a descrambler for descrambling the PID-filtered transport stream packet (TSP) using the hardware;
a section filter detecting a section as a transfer unit for transferring program information and user information in the PID-filtered and descrambled data and filtering the detected section in accordance with a section pattern;
a CRC checking unit for detecting a cyclic redundancy check error (CRC error) of the section.

7. A transport stream processing apparatus as claimed in claim 1, wherein
the hardware transport stream separating device comprises as components for executing the plurality of processings:
a synchronizing unit for retrieving the data from the inputted transport stream (TS) per a transport stream packet (TSP);
a PID filter for filtering the inputted transport stream packet (TSP) in accordance with identification data (PID);
a descrambler for descrambling the PID-filtered transport stream packet (TSP) using the hardware;
a PES packet filter for detecting a PES packet as a transfer unit for transferring image, audio and subtitle in the PID-filtered and descrambled data and filtering the detected PES packet in accordance with a PES packet pattern.

8. A transport stream processing apparatus as claimed in claim 1, wherein
the hardware transport stream separating device comprises as components for executing the plurality of processings:
a synchronizing unit for retrieving the data from the inputted transport stream (TS) per a transport stream packet (TSP);
a PID filter for filtering the inputted transport stream packet (TSP) in accordance with identification data (PID);
a descrambler for descrambling the PID-filtered transport stream packet (TSP) using the hardware;
a service information (SI) replacing unit for generating the transport stream packet (TSP) including a section required when a partial transport stream (partial TS) is outputted and synthesizing the generated TSP and the descrambled transport stream packet (TSP); and
a partial TS output unit for outputting the transport stream packet (TSP) synthesized in the service information (SI) replacing unit as the partial TS.

9. A transport stream processing method for executing a plurality of processings for separating desired data from a transport stream (TS) comprising:
a hardware processing step for executing the plurality of procesings using a hardware constitution;
a software processing step for executing another processing using a software constitution, the another processing different to a part of the plurality of processings (hereinafter, referred to as partial processing) but obtaining a same processing result as that of the partial processing;
a memorizing step for reading data currently being processed in the hardware processing step and to be processed in the software processing step from the hardware processing step and storing the read data in a memorizing device accessible by the software constitution; and
a switching step for switching to and from the hardware processing step and the software processing step in executing the partial processing, wherein
the memorizing step executes the processing of the software processing step when the switching step instructs execution of the software processing step, and
the software processing step reads and processes the data to be processed memorized in the memorizing device in the memorizing step when the switching step instructs the execution of the software processing step.

10. A transport stream processing method as claimed in claim 9, wherein
the software processing step includes:
a step of reading the data to be processed stored in the memorizing device in the memorizing step and processing the read data in the another processing;
a step of storing the data processed in the another processing in the memorizing device; and
a step of reading the processed data stored in the memorizing device and inputting the read data to a residual processing executed in the hardware processing step after the partial processing.

11. A transport stream processing method as claimed in claim 9, wherein
the switching step switches to and from the processing of the hardware processing step and the processing of the software processing step in response to a processing adaptation status of the transport stream (TS) processed in the partial processing.

12. A transport stream processing method as claimed in claim 9, wherein
the partial processing includes a descrambling processing using the hardware with respect to the transport stream (TS), and
the another processing includes a descrambling processing using the software with respect to the transport stream (TS).

13. A transport stream processing method as claimed in claim 12, wherein
the processing switching step includes a step of setting a descramble switching flag in accordance with the processing adaptation status and executes the hardware processing step when the descramble switching flag is ineffective, and
the processing switching step executes the software processing step when the descramble switching flag is effective.

14. A transport stream processing method as claimed in claim 12, wherein
the processing switching step judges whether or not the transport stream (TS) can be descrambled in the hardware processing step based on a scramble state of the transport stream (TS) and switches to and from the hardware processing step and the software processing step based on a result of the judgment.

15. A transport stream processing method as claimed in claim 9, wherein the hardware processing step includes as steps for executing the plurality of processings:
a synchronizing step for retrieving the data from the inputted transport stream (TS) per a transport stream packet (TSP);
a PID filtering step for filtering the inputted transport stream packet (TSP) in accordance with identification data (PID);
a hardware descrambling step for descrambling the PID-filtered transport stream packet (TSP) using the hardware;
a section filtering step for detecting a section as a transfer unit for transferring program information and user information in the PID-filtered and descrambled data and filtering the detected section in accordance with a section pattern; and
a CRC checking step for detecting a CRC error of the section.

16. A transport stream processing method as claimed in claim 9, wherein the hardware processing step includes as steps for executing the plurality of processings:
a synchronizing step for retrieving the data from the inputted transport stream (TS) per a transport stream packet (TSP);
a PID filtering step for filtering the inputted transport stream packet (TSP) in accordance with identification data (PID);
a descrambling step for descrambling the PID-filtered transport stream packet (TSP) using the hardware;
a PES packet filtering step for detecting a PES packet as a transfer unit for transferring image, audio and subtitle in the PID-filtered and descrambled data and filtering the detected PES packet in accordance with a PES packet pattern.

17. A transport stream processing method as claimed in claim 9, wherein the hardware processing step includes as steps for executing the plurality of processings:
a synchronizing step for retrieving the data from the inputted transport stream (TS) per a transport stream packet (TSP);
a PID filtering step for filtering the inputted transport stream packet (TSP) in accordance with identification data (PID);
a descrambling step for descrambling the PID-filtered transport stream packet (TSP) using the hardware;
a service information (SI) replacing step for generating the transport stream packet (TSP) including a section required when a partial transport stream (partial TS) is outputted and synthesizing the generated TSP and the descrambled transport stream packet (TSP); and
a partial TS output step for outputting the transport stream packet (TSP) synthesized in the service information (SI) replacing step as the partial TS.

18. A digital broadcast receiver comprising a tuner for receiving a digital broadcast including the transport stream (TS) and the transport stream processing apparatus claimed in claim 1.
